(19) United States
(12) Patent Application Publication
(10) Pub. No.: US 2018/0020209 A1
(43) Pub. Date: Jan. 18, 2018

(54) Integrated Camera System Having Two Dimensional Image Capture and Three Dimensional Time-of-Flight Capture With A Partitioned Field of View

(71) Applicant: Google Inc., Mountain View, CA (US)

(72) Inventors: Jamyuen Ko, San Jose, CA (US); Chung Chun Wan, Fremont, CA (US)

(21) Appl. No.: 15/694,039

(22) Filed: Sep. 1, 2017

Related U.S. Application Data
(62) Division of application No. 15/693,553, filed on Sep. 1, 2017.
Application No. 15/693,553 is a continuation of application No. 14/579,732, filed on Dec. 22, 2014.

(51) Int. Cl. H04N 13/02; G01S 17/89; G01S 7/481; H04N 5/222; H04N 5/225; H04N 5/33

(52) U.S. Cl. CPC H04N 13/0253; H04N 5/2257; H04N 13/0296; H04N 13/0289; H04N 5/332; G01S 7/4815; H04N 5/2256; H04N 5/2226; G01S 17/89; H04N 2213/001

(57) ABSTRACT

An apparatus is described that includes an integrated two-dimensional image capture and three-dimensional time-of-flight depth capture system. The three-dimensional time-of-flight depth capture system includes an illuminator to generate light. The illuminator includes arrays of light sources. Each of the arrays is dedicated to a particular different partition within a partitioned field of view of the illuminator.

### RELATED APPLICATIONS

This application is a divisional of U.S. application Ser. No. 15/693,553, filed Sep. 1, 2017, which is a continuation of U.S. application Ser. No. 14/579,732, filed Dec. 22, 2014, the contents of which are hereby incorporated by reference.

### FIELD OF INVENTION

The field of invention pertains to camera systems generally, and, more specifically, to an integrated camera system having two dimensional image capture and three dimensional time-of-flight capture with a partitioned field of view

### BACKGROUND

Many existing computing systems include one or more traditional image capturing cameras as an integrated peripheral device. A current trend is to enhance computing system imaging capability by integrating depth capturing into its imaging components. Depth capturing may be used, for example, to perform various intelligent object recognition functions such as facial recognition (e.g., for secure system un-lock) or hand gesture recognition (e.g., for touchless user interface functions).

One depth information capturing approach, referred to as “time-of-flight” imaging, emits light from a system onto an object and measures, for each of multiple pixels of an image sensor, the time between the emission of the light and the reception of its reflected image upon the sensor. The image produced by the time of flight pixels corresponds to a three-dimensional profile of the object as characterized by a unique depth measurement (z) at each of the different (x,y) pixel locations.

As many computing systems with imaging capability are mobile in nature (e.g., laptop computers, tablet computers, smartphones, etc.), the integration of a light source (“illuminator”) into the system to achieve time-of-flight operation presents a number of design challenges such as cost challenges, packaging challenges and/or power consumption challenges.

### SUMMARY

An apparatus is described that includes an integrated two-dimensional image capture and three-dimensional time-of-flight depth capture system. The three-dimensional time-of-flight depth capture system includes an illuminator to generate light. The illuminator includes arrays of light sources. Each of the arrays is dedicated to a particular different partition within a partitioned field of view of the illuminator.

An apparatus is described that includes means for receiving a command to illuminate a particular partition of a partitioned field of view of an illuminator. The apparatus additionally includes means for enabling an array of light sources that is dedicated to the particular partition. The apparatus additionally includes means for collecting light from the light source array and directing the collected light toward the partition to illuminate the partition. The apparatus additionally includes means for detecting at least a portion of the light after it has been reflected from an object of interest within the partition and comparing respective arrival times of the light against emission times of the light to generate depth information of the object of interest.

### FIGURES

The following description and accompanying drawings are used to illustrate embodiments of the invention. In the drawings:

FIG. 1a shows an embodiment of an illuminator having a partitioned field of view;

FIG. 1b shows a first perspective of an embodiment of the illuminator of FIG. 1a;

FIG. 1c shows a second perspective of an embodiment of the illuminator of FIG. 1a;

FIG. 1d shows a first partition being illuminated;

FIG. 1e shows a second partition being illuminated;

FIG. 1f shows a sequence of partitions being illuminated in succession;

FIG. 1g shows a second embodiment of the illuminator of FIG. 1a;

FIG. 1h shows a third embodiment of the illuminator of FIG. 1a;

FIG. 2a shows a first embodiment of a field of view partitioning scheme and corresponding arrangement of light source arrays;

FIG. 2b shows a second embodiment of a field of view partitioning scheme and corresponding arrangement of light source arrays;

FIG. 2c shows a third embodiment of a field of view partitioning scheme and corresponding arrangement of light source arrays;

FIG. 2d shows a fourth embodiment of a field of view partitioning scheme and corresponding arrangement of light source arrays;

FIG. 2e shows a fifth embodiment of a field of view partitioning scheme and corresponding arrangement of light source arrays;

FIG. 2f shows a sixth embodiment of a field of view partitioning scheme and corresponding arrangement of light source arrays;

FIG. 2g shows a seventh embodiment of a field of view partitioning scheme and corresponding arrangement of light source arrays;

FIG. 3a shows a first perspective of an integrated two-dimensional image capture and three-dimensional time-of-flight system;

FIG. 3b shows a second perspective of the integrated two-dimensional image capture and three-dimensional time-of-flight system of FIG. 3a;

FIG. 3c shows a methodology performed by the system of FIGS. 3a and 3b;

FIG. 4 shows an embodiment of a computing system.

### DETAILED DESCRIPTION

A “smart illumination” time-of-flight system addresses some of the design challenges referred to in the Background section. As will be made more clear in the following discussion, a “smart illumination” time-of-flight system can emit light on only a “region of interest” within the illuminator's field of view. As a consequence, the intensity of the emitted optical signal is strong enough to generate a detectable signal at the image sensor, while, at the same time, the illuminator's power consumption does not appreciably draw from the computer system's power supply.

One smart illumination approach is to segment the illuminator's field of view into different partitions and to reserve a separate and distinct array of light sources for each different partition.

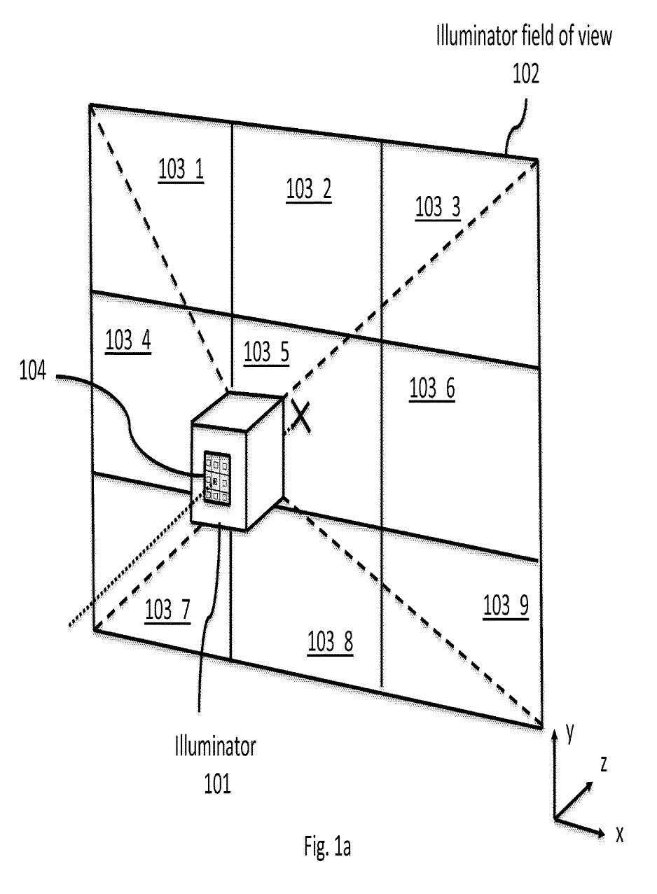

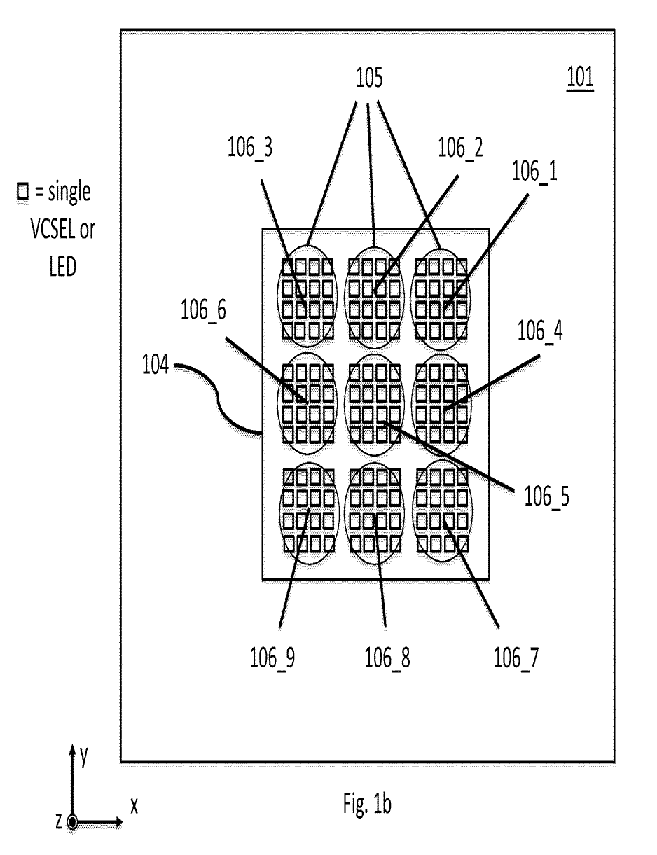

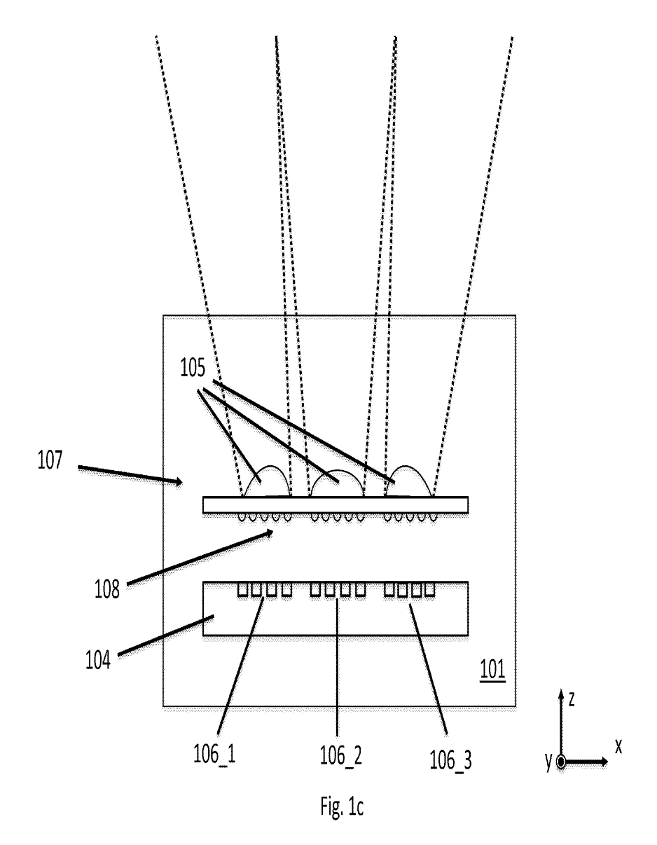

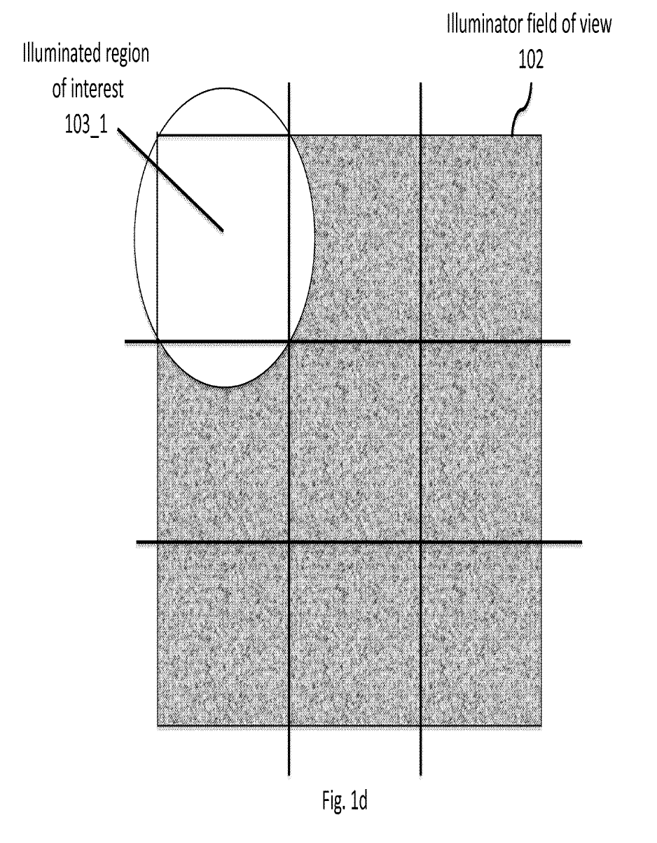

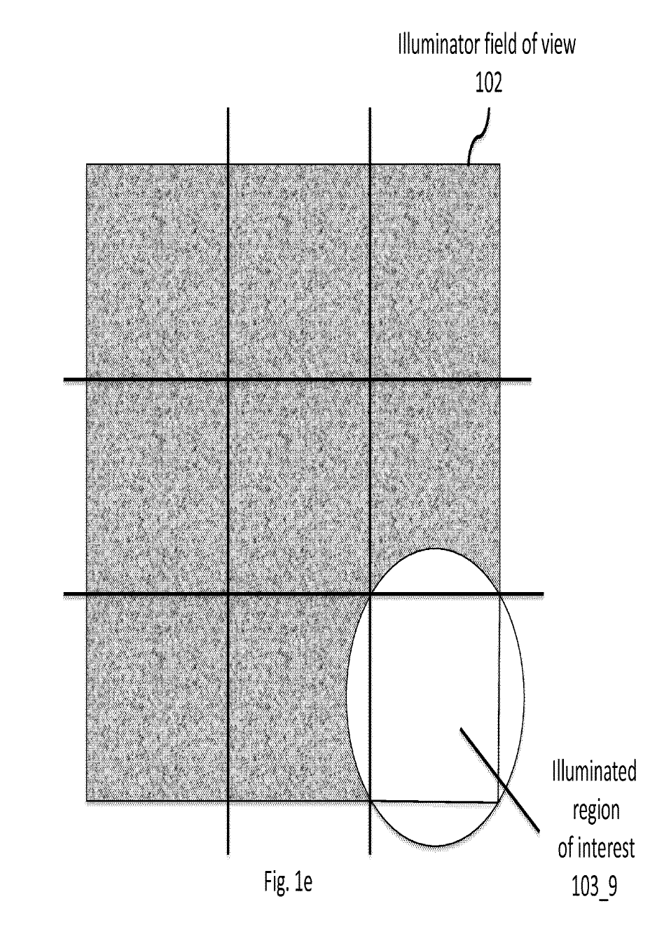

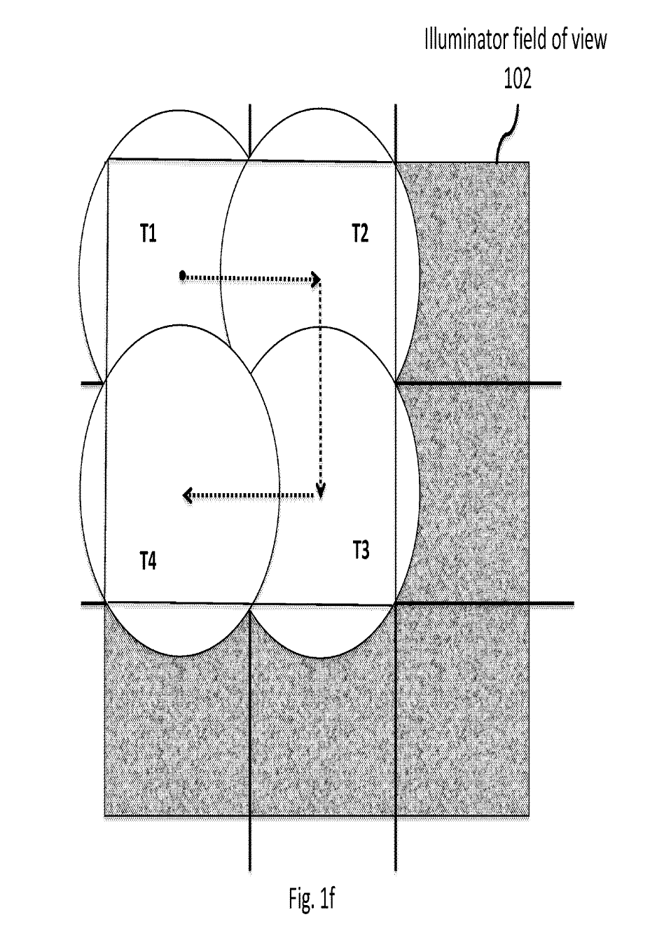

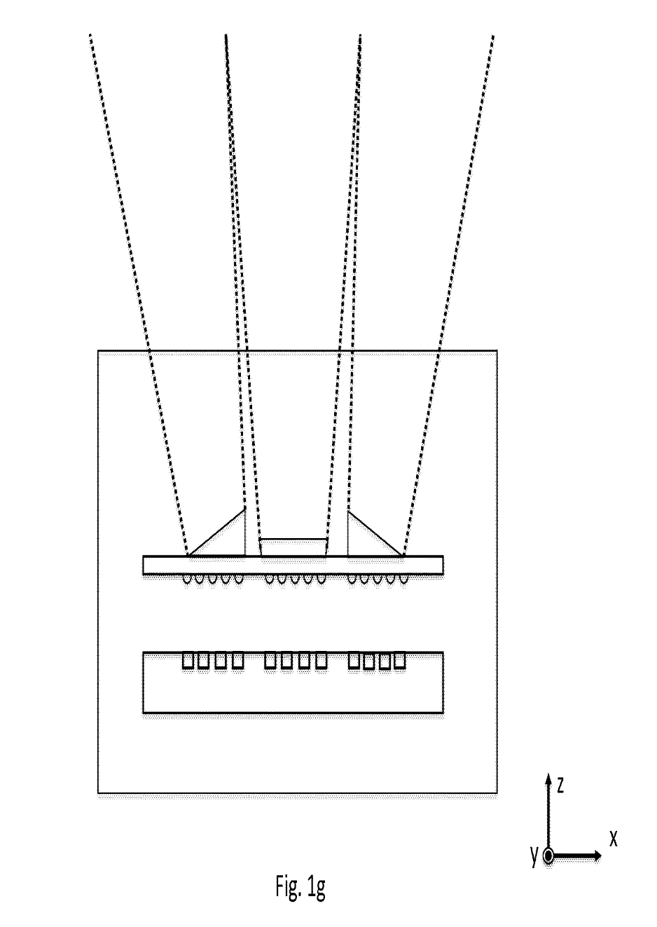

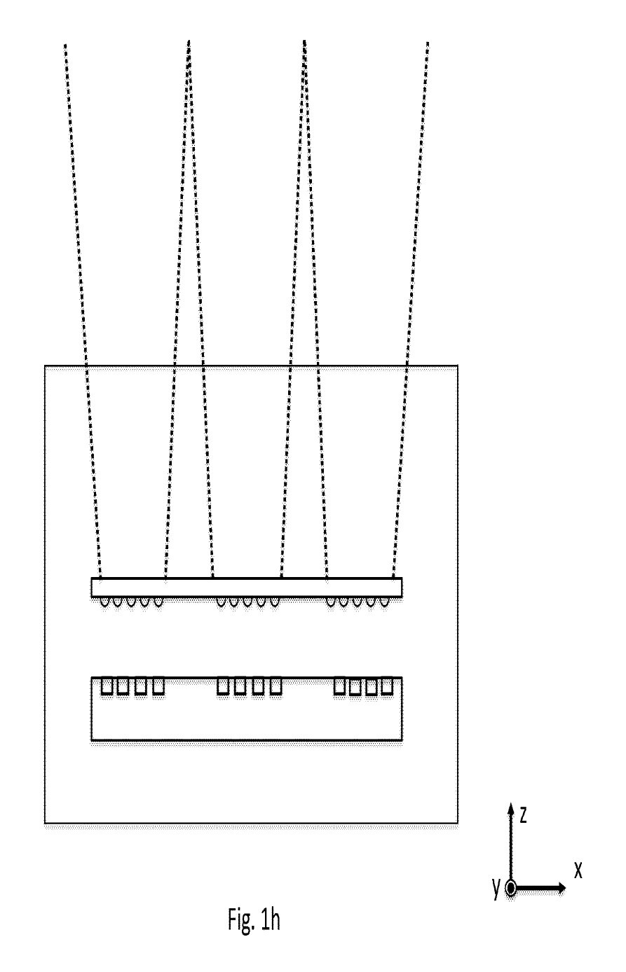

Referring to FIGS. 1a through 1c, illuminator 101 possesses a field of view 102 that is partitioned into nine sections 103_1 through 103_9. A light source array chip 104 that resides beneath the optics 107 of the illuminator 101 has a distinct set of light source arrays 106_1 through 106_9, where, each light source array is reserved for one of the field of view sections. As such, in order to illuminate a particular section of the field of view, the light source array for the particular section is enabled or “on”. For example, referring to FIGS. 1a, 1b and 1 d, if section 103_1 of the field of view is to be illuminated, light source array 106_1 is enabled. By contrast, referring to FIGS. 1a, 1b and 1e, if section 103_9 of the field of view is to be illuminated, light source array 106_9 is enabled.

The reservation of an entire light source array for only a distinct partition of the field of view 102 ensures that light of sufficient intensity is emitted from the illuminator 101, which, in turn, ensures that a signal of appreciable strength will be received at the image sensor. The use of an array of light sources is known in the art. However, a single array is typically used to illuminate an entire field of view rather than just a section of it.

In many use cases it is expected that only a portion of the field of view 102 will be “of interest” to the application that is using the time-of-flight system. For example, in the case of a system designed to recognize hand gestures, only the portion of the field of view consumed by the hand needs to be illuminated. Thus, the system has the ability to direct the full intensity of an entire light source array onto only a smaller region of interest.

In cases where the region of interest consumes more than one partitioned section, the sections can be illuminated in sequence to keep the power consumption of the overall system limited to no more than a single light source array. For example, referring to FIG. 1f, if the region of interest includes sections 103_1, 103_2, 103_4 and 103_5, at a first moment in time t1, only array 106_1 is enabled and only section 103_1 is illuminated, at a second moment in time t2, only array 106_2 is enabled and only section 103_2 is illuminated, at a third moment in time t3, only array 106_5 is enabled and only section 103_5 is illuminated, and, at a fourth moment in time t4, only array 106_4 is enabled and only section 103_4 is illuminated.

That is, across times t1 through t4, different partitions are turned on and off in sequence to effectively “scan” an amount of light equal to a partition across the region of interest. A region of interest that is larger than any one partition has therefore been effectively illuminated. Importantly, at any one of moments of time t1 through t4, only one light source array is “on”. As such, over the course of the scanning over the larger region of interest, the power consumption remains approximately that of only a single array. In various other use cases more than one light source array may be simultaneously enabled with the understanding that power consumption will scale with the number of simultaneously enabled arrays. That is, there may be use cases in which the power consumption expense is permissible for a particular application that desires simultaneous illumination of multiple partitions.

As observed in FIGS. 1b and 1c, the illuminator 101 includes a semiconductor chip 104 having a light source array 106_1 through 106_9 for each partition of the field of view 102. Although the particular embodiment of FIGS. 1a through 1f show nine field of view sections arranged in an orthogonal grid, other numbers and/or arrangements of partitions may be utilized as described in more detail further below. Likewise, although each light source array is depicted as a same sized N×N square array, as discussed in more detail below, other array patterns and/or shapes including different sized and/or shaped arrays on a same semiconductor die may be utilized.

Each light source array 106_1 through 106_9 may be implemented, for example, as an array of light-emitted-diodes (LEDs) or lasers such as vertical cavity surface emitting lasers (VCSELs). In a typical implementation the respective light sources of each array emit non-visible (e.g., infra-red (IR)) light so that the reflected time-of-flight signal does not interfere with the traditional visible light image capture function of the computing system. Additionally, in various embodiments, each of the light sources within a particular array may be connected to the same anode and same cathode so that all of the light sources within the array are either all on or all off (alternative embodiments could conceivably be designed to permit subsets of light sources within an array to be turned on/off together (e.g., to illuminate sub-regions within a partition).

An array of light sources permits, e.g., the entire illuminator power budget to be expended illuminating only a single partition. For example, in one mode of operation, a single light source array is on and all other light source arrays are off so that the entire power budget made available to the illuminator is expended illuminating only the light source array's particular partition. The ability to direct the illuminator's full power to only a single partition is useable, e.g., to ensure that any partition can receive light of sufficient intensity for a time-of-flight measurement. Other modes of operation may scale down accordingly (e.g., two partitions are simultaneously illuminated where the light source array for each consumes half of the illuminator's power budget by itself). That is, as the number of partitions that are simultaneously illuminated grows, the amount of optical intensity emitted towards each partition declines. Referring to FIGS. 1b and 1c, in an embodiment, the illuminator 101 also includes an optical element 107 having a micro-lens array 108 on a bottom surface that faces the semiconductor chip 104 and having an emission surface with distinct lens structures 105 for each partition to direct light received from its specific light source array to its corresponding field of view partition. Each lens of the micro-lens array 108 essentially behaves as a smaller objective lens that collects divergent light from the underlying light sources and shapes the light to be less divergent internal to the optical element as the light approaches the emission surface. In one embodiment, there is a micro-lens allocated to and aligned with each light source in the underlying light source array although other embodiments may exist where there is more or less micro-lenses per light source for any particular array.

The micro-lens array 108 enhances optical efficiency by capturing most of the emitted optical light from the underlying laser array and forming a more concentrated beam. Here, the individual light sources of the various arrays typically have a wide emitted light divergence angle. The micro-lens array 108 is able to collect most/all of the diverging light from the light sources of an array and help form an emitted beam of light having a smaller divergence angle.

Collecting most/all of the light from the light source array and forming a beam of lower divergence angle essentially forms a higher optical bower beam (that is, optical intensity per unit of surface area is increased) resulting in a stronger received signal at the sensor for the region of interest that is illuminated by the beam. According to one calculation, if the divergence angle from the light source array is 60°, reducing the emitted beam's divergence angle to 30° will increase the signal strength at the sensor by a factor of 4.6. Reducing the emitted beam's divergence angle to 20° will increase the signal strength at the sensor by a factor of 10.7.

Boosting received signal strength at the sensor through optical concentration of emitted light from the light source array, as opposed to simply emitting higher intensity light from the light source array, preserves battery life as the light source array will be able to sufficiently illuminate an object of interest without consuming significant amounts of power.

The design of optical element 107 as observed in FIG. 1c naturally diffuses the light that is collected from the light source arrays 106. That is, the incident light that is collected by underlying micro-lenses 108 tend to “scatter” within the optical element 107 prior to its emission by a corresponding exit lens 105 for a particular partition. The diffusive action of the optical element 107 helps to form a light beam of substantially uniform intensity as emitted from an exit lens, which, in turn, enhances the accuracy of the time-of-flight measurement. The optical element 107 may be made further diffusive by, e.g., constructing the element 107 with materials that are translucent in the IR spectrum and/or otherwise designing the optical path within the element 107 to impose scattering internal reflections (such as constructing the element 107 as a multi-layered structure). As mentioned briefly above, the emission surface of the optical element 107 may include distinctive lens structures 105 each shaped to direct light to its correct field of view partition. As observed in the specific embodiment of FIGS. 1b and 1c, each lens structure 105 has a rounded convex shape. Other embodiments, as observed in FIGS. 1g and 1h, may have sharper edged trapezoidal shapes (FIG. 1g) or no structure at all (FIG. 1h).

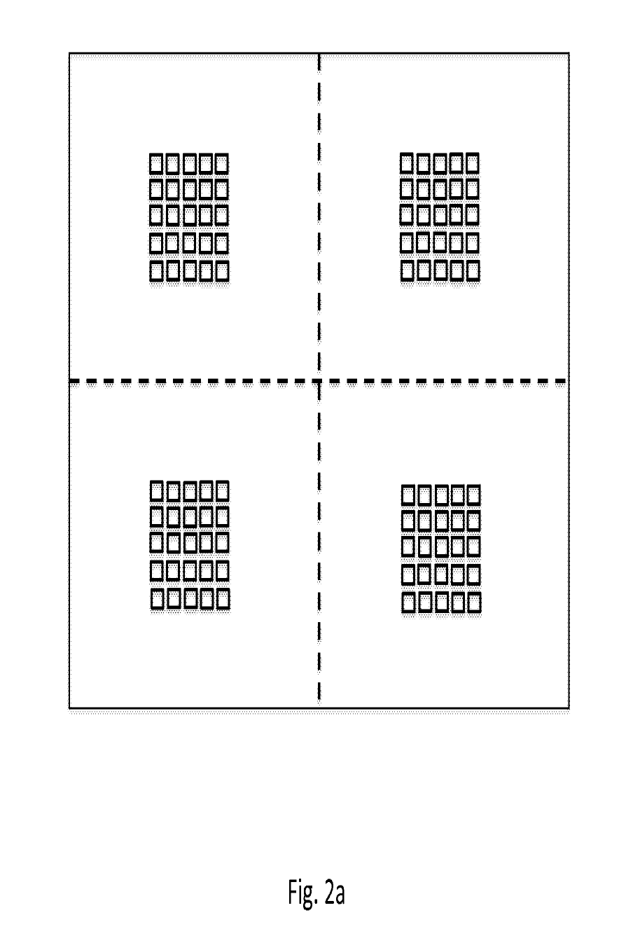

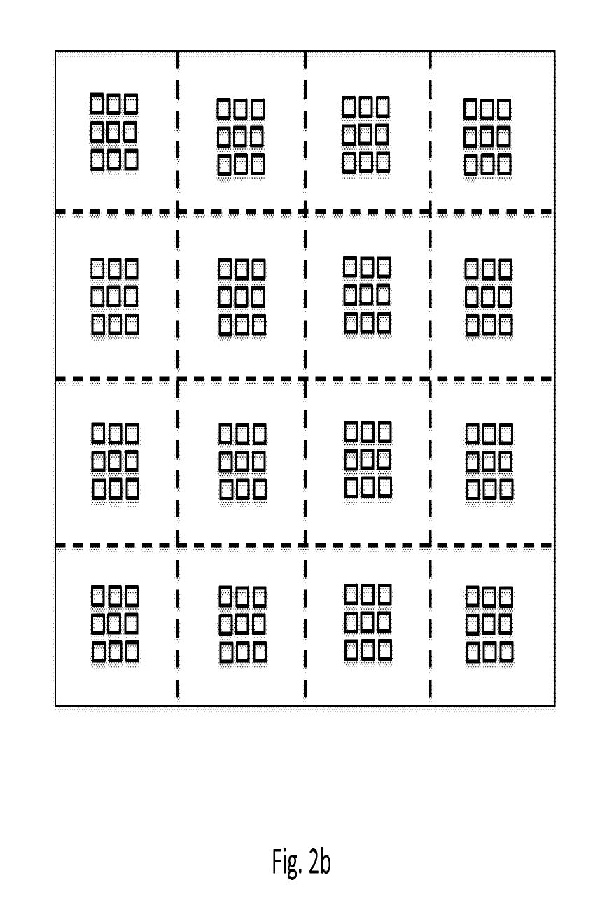

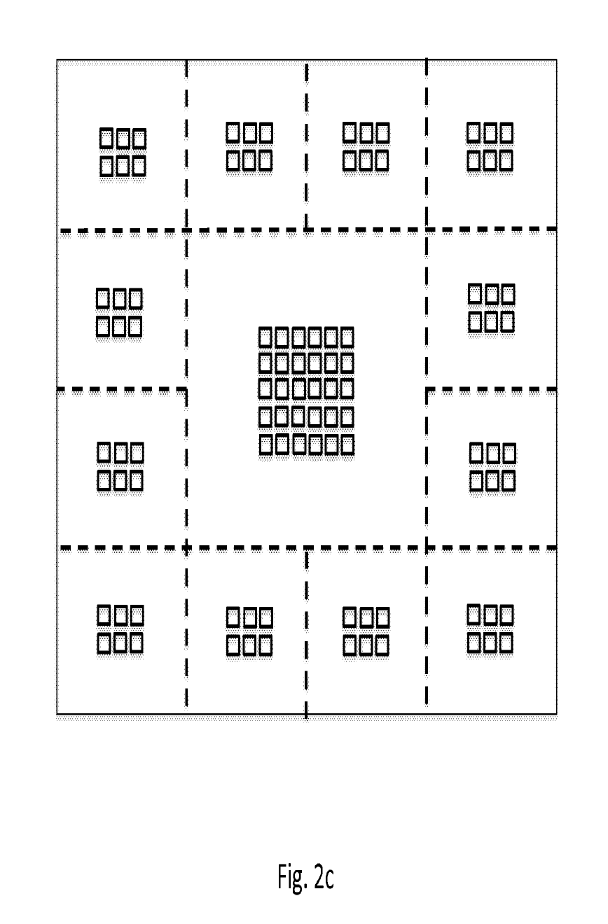

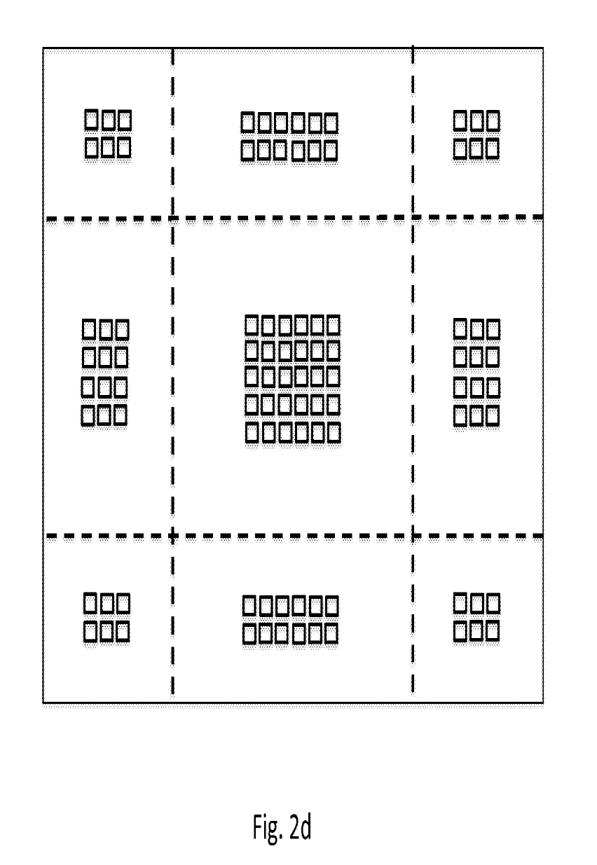

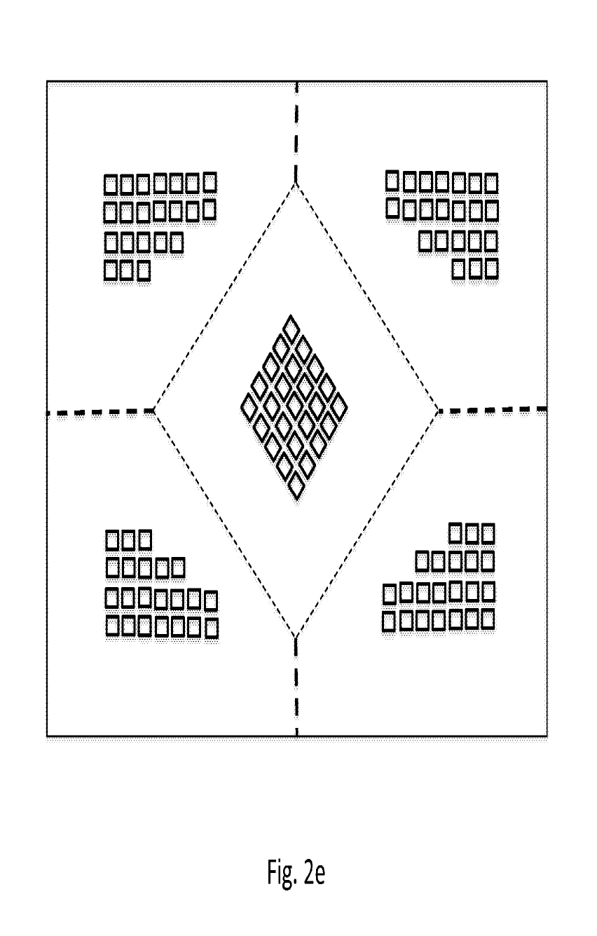

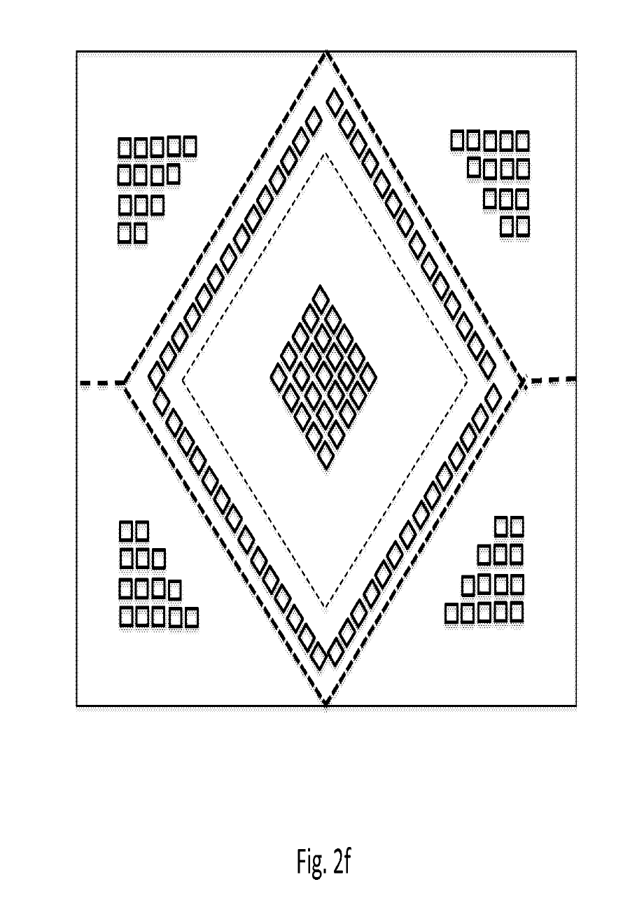

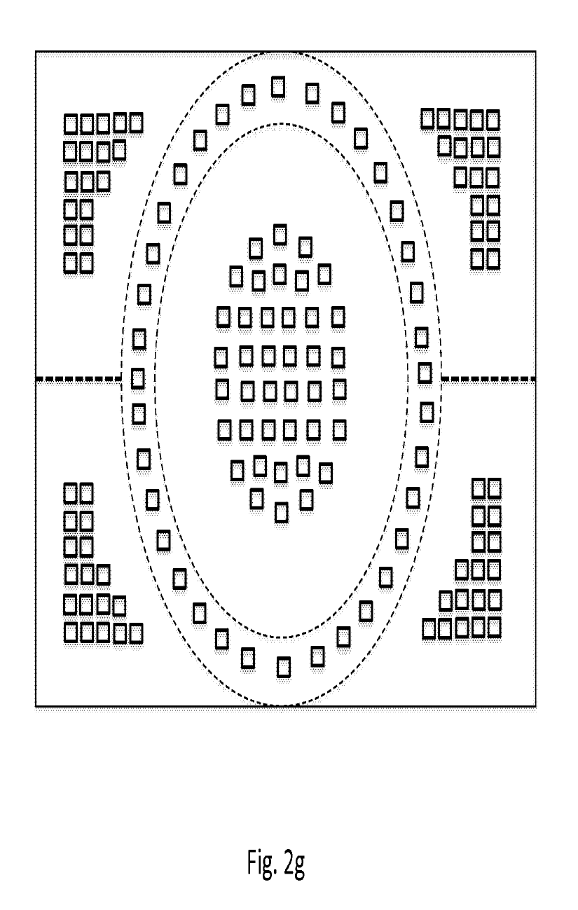

FIG. 2a through 2g show various schemes for partitioning the field of view and their corresponding light array patterns. FIG. 2a shows a quadrant partitioned approach that partitions the field of view into only four sections. FIG. 2b, by contrast, shows another approach in which the field of view is partitioned into sixteen different sections. Like the embodiment of FIGS. 1a through 1f, the embodiments FIGS. 2a and 2b include equal sized square or rectangular field of view partitions. Note that the size of the corresponding light source arrays scale with the size of their corresponding field of view. That is, the smaller the size of the field of view partition, the less light sources are needed to illuminate it. As such, the number of light sources in the array (the size of the array) can likewise diminish.

FIG. 2c shows an embodiment having a larger centered field of view section and smaller, surrounding sections. The embodiment of FIG. 2c may be chosen, for example, if the computing system is expected to execute one or more applications where the object of interest for time-of-flight depth measurements is expected to be centered in the illuminator's field of view but is not expected to be large enough to consume the entire field of view. Such applications may include various intelligent object recognition functions such as hand gesture recognition and/or facial recognition. A pertinent observation of the partitioning scheme of FIG. 2c is that, unlike the embodiments of FIGS. 2a and 2b, the various field of view sections are not all of the same size. Likewise, their corresponding light source array patterns are not all of the same size. Additionally, the lens structure on the emission surface of the illuminator optics would include a larger lens structure for the center partition than the lens structures used to direct light to the smaller surrounding partitions.

FIG. 2d shows another embodiment having a centered field of view section and smaller surrounding sections, however, the smaller surrounding sections have different shapes and/or sizes as amongst themselves. Likewise, the light source arrays as implemented on the semiconductor die not only have a larger centered array but also have differently shaped and/or sized arrays surrounding the larger center array. Additionally, the lens structures of the emission surface of the illuminator optics element would include a larger lens structure in the center and two additional differently sized/shaped lens structures around the periphery of the center lens structure.

The embodiment of FIG. 2d may be useful in cases where the computing system is expected to execute one or more applications where the object of interest for time-of-flight depth measurements is expected to be centered in the illuminator's field of view but its size may range from small to large. Here, illumination of surrounding sections help to illuminate larger sections of the field just outside the center of the field of view.

FIG. 2e shows another embodiment that uses a centered section, however, the section is oriented as an angled square rather than an orthogonally oriented square. The design approach results in the formation of quasi-triangular shaped sections in the corners of the field of view (as opposed to square or rectangular shaped sections as in the embodiments of FIGS. 2a through 2d). Other embodiments, e.g., having a different sized center region and field of view aspect ratio may form pure triangles at the corners.

FIG. 2f show another angled center design but where the center region has inner and outer partitions so that the amount of illumination in the center of the field of view can be adjusted. Other embodiments may have more than one partition that completely surrounds the center region (partitions of multiple concentric rings). Here, each additional surrounding partition would not only surround the center region but also any smaller inner surrounding regions as well.

FIG. 2g shows an approach that uses an oval shaped center approach with a surrounding partition around the center oval. Like the approach of FIG. 2f, the approach of FIG. 2g can also illuminate different sized regions in the center of the field of view. Also like the approach of FIG. 2f, other embodiments may have more than one partition that completely surrounds the center region (partitions of multiple concentric rings). Here, each additional surrounding partition would not only surround the center region but also any smaller inner surrounding regions as well. Other embodiments may use a circular inner region rather than an oval inner region.

It is pertinent to recognize that with any of the partition designs of FIGS. 2a through 2g a series of partitions may be illuminated in succession to effectively illuminate a larger area over a period of time as discussed above with respect to FIG. 1f.

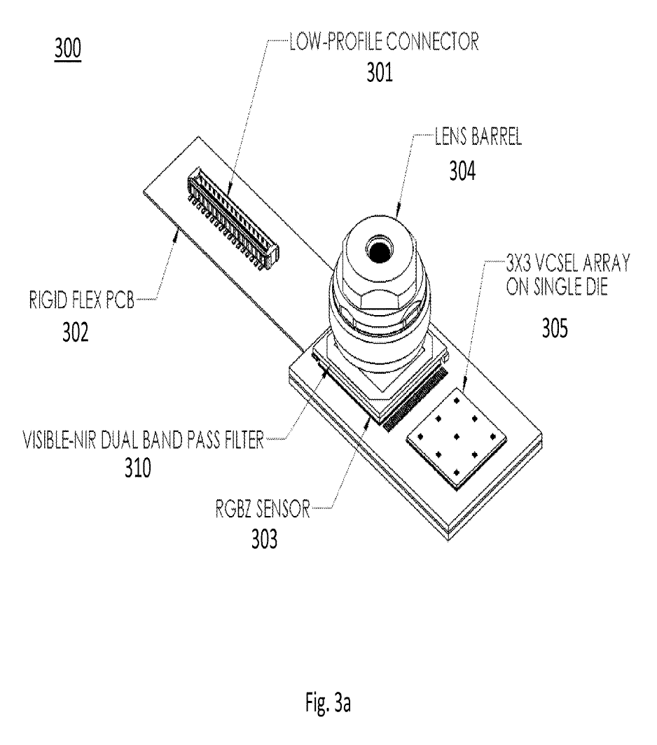

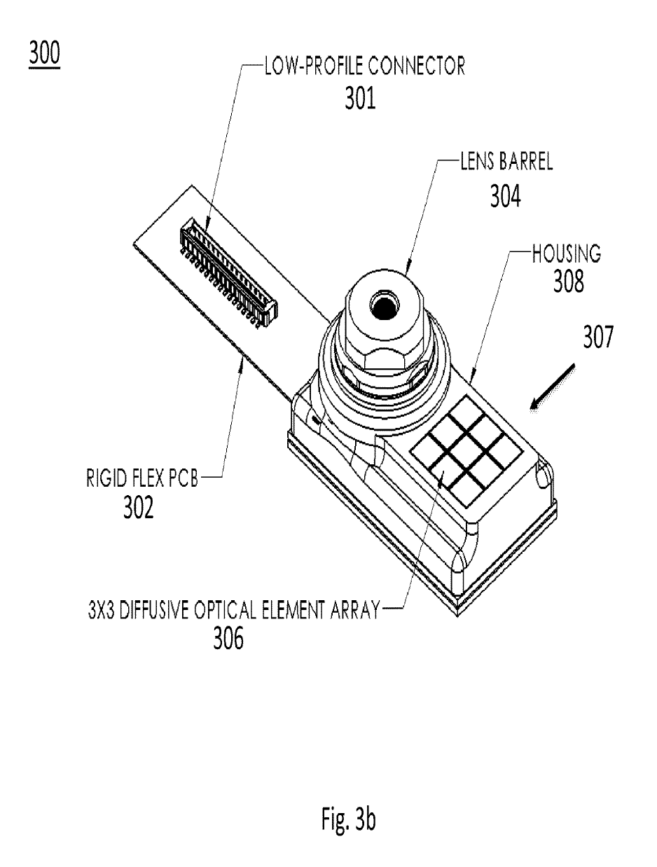

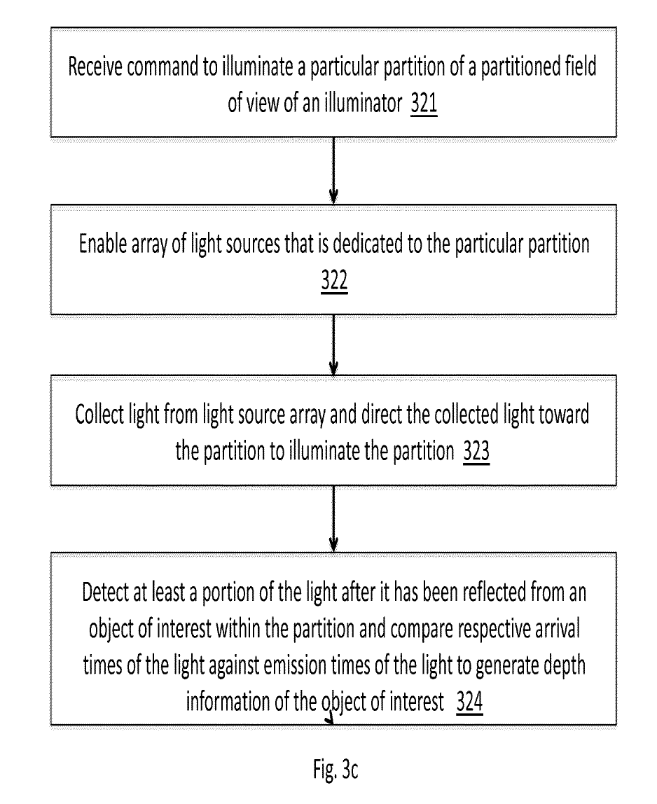

FIGS. 3a and 3b show different perspectives of an integrated traditional camera and time-of-flight imaging system 300. FIG. 3a shows the system with the illuminator 307 housing 308 and optical element 306 removed so that the plurality of light source arrays 305 is observable. FIG. 3b shows the complete system with the illuminator housing 308 and the exposed optical element 306.

The system 300 has a connector 301 for making electrical contact, e.g., with a larger system/mother board, such as the system/mother board of a laptop computer, tablet computer or smartphone. Depending on layout and implementation, the connector 301 may connect to a flex cable that, e.g., makes actual connection to the system/mother board, or, the connector 301 may make contact to the system/mother board directly.

The connector 301 is affixed to a planar board 302 that may be implemented as a multi-layered structure of alternating conductive and insulating layers where the conductive layers are patterned to form electronic traces that support the internal electrical connections of the system 300. Through the connector 301 commands are received from the larger system to turn specific ones of the light source arrays on and turn specific ones of the light source arrays off.

An integrated “RGBZ” image sensor 303 is mounted to the planar board 302. The integrated RGBZ sensor includes different kinds of pixels, some of which are sensitive to visible light (specifically, a subset of R pixels that are sensitive to visible red light, a subset of G pixels that are sensitive to visible green light and a subset of B pixels that are sensitive to blue light) and others of which are sensitive to IR light. The RGB pixels are used to support traditional “2D” visible image capture (traditional picture taking) functions. The IR sensitive pixels are used to support 2D IR image capture and 3D depth profile imaging using time-of-flight techniques. Although a basic embodiment includes RGB pixels for the visible image capture, other embodiments may use different colored pixel schemes (e.g., Cyan, Magenta and Yellow).

The integrated image sensor 303 may also include, for the IR sensitive pixels, special signaling lines or other circuitry to support time-of-flight detection including, e.g., clocking signal lines and/or other signal lines that indicate the timing of the reception of IR light (in view of the timing of the emission of the IR light from the light source array 305).

The integrated image sensor 303 may also include a number or analog-to-digital converters (ADCs) to convert the analog signals received from the sensor's RGB pixels into digital data that is representative of the visible imagery in front of the camera lens module 304. The planar board 302 may likewise include signal traces to carry digital information provided by the ADCs to the connector 301 for processing by a higher end component of the computing system, such as an image signal processing pipeline (e.g., that is integrated on an applications processor).

A camera lens module 304 is integrated above the integrated RGBZ image sensor 303. The camera lens module 304 contains a system of one or more lenses to focus light received through an aperture onto the image sensor 303. As the camera lens module's reception of visible light may interfere with the reception of IR light by the image sensor's time-of-flight pixels, and, contra-wise, as the camera module's reception of IR light may interfere with the reception of visible light by the image sensor's RGB pixels, either or both of the image sensor 302 and lens module 303 may contain a system of filters (e.g., filter 310) arranged to substantially block IR light that is to be received by RGB pixels, and, substantially block visible light that is to be received by time-of-flight pixels.

An illuminator 307 composed of a plurality of light source arrays 305 beneath an optical element 306 that partitions the illuminator's field of view is also mounted on the planar board 302. The plurality of light source arrays 305 may be implemented on a semiconductor chip that is mounted to the planar board 301. Embodiments of the light source arrays 305 and partitioning of the optical element 306 have been discussed above with respect to FIGS. 1a through 1 h and 2a through 2g.

Notably, one or more supporting integrated circuits for the light source array (not shown in FIG. 3a) may be mounted on the planar board 301. The one or more integrated circuits may include LED or laser driver circuitry for driving respective currents through the light source array's light sources and coil driver circuitry for driving each of the coils associated with the voice coil motors of the movable lens assembly. Both the LED or laser driver circuitry and coil driver circuitry may include respective digital-to-analog circuitry to convert digital information received through connector 301 into a specific current drive strength for the light sources or a voice coil. The laser driver may additionally include clocking circuitry to generate a clock signal or other signal having a sequence of 1s and 0s that, when driven through the light sources will cause the light sources to repeatedly turn on and off so that the depth measurements can repeatedly be made.

In an embodiment, the integrated system 300 of FIGS. 3a and 3b support three modes of operation: 1) 2D mode; 3) 3D mode; and, 3) 2D/3D mode. In the case of 2D mode, the system behaves as a traditional camera. As such, illuminator 307 is disabled and the image sensor is used to receive visible images through its RGB pixels. In the case of 3D mode, the system is capturing time-of-flight depth information of an object in the field of view of the illuminator 307 and the camera lens module 304. As such, the illuminator is enabled and emitting IR light (e.g., in an on-off-on-off . . . sequence) onto the object. The IR light is reflected from the object, received through the camera lens module 304 and sensed by the image sensor's time-of-flight pixels. In the case of 2D/3D mode, both the 2D and 3D modes described above are concurrently active.

FIG. 3c shows a method that can be performed by the system of FIGS. 3a and 3b. As observed in FIG. 3c, a command is received to illuminate a particular partition within a partitioned field of view of illuminator 321. In response to the command a specific array of light sources that is dedicated to the partition is enabled 322. Light from the light source array is collected and directed to the partition to illuminate the partition 323. The system detects at least a portion of the light after it has been reflected from an object of interest within the partition and compares respective arrival times of the light against emission times of the light to generate depth information of the object of interest 324.

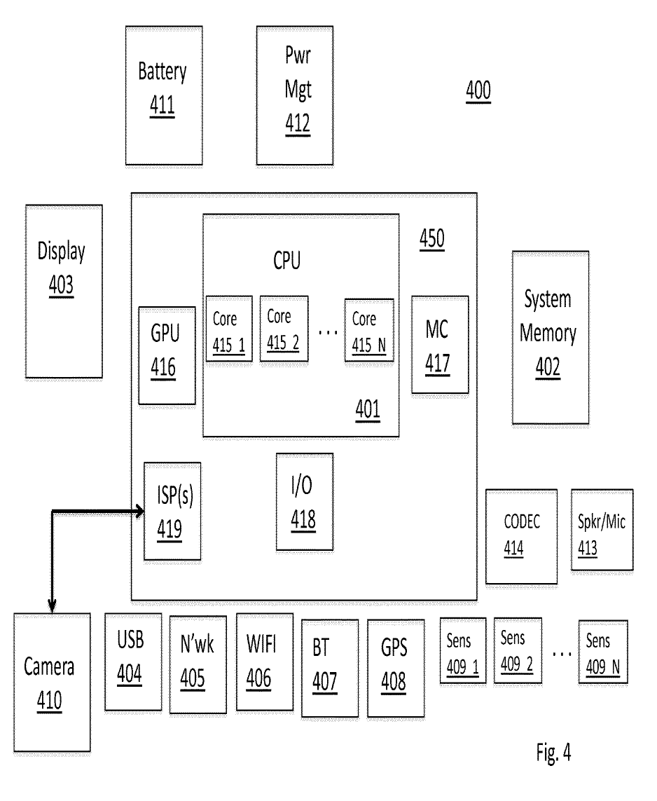

FIG. 4 shows a depiction of an exemplary computing system 400 such as a personal computing system (e.g., desktop or laptop) or a mobile or handheld computing system such as a tablet device or smartphone. As observed in FIG. 4, the basic computing system may include a central processing unit 401 (which may include, e.g., a plurality of general purpose processing cores) and a main memory controller 417 disposed on an applications processor or multi-core processor 450, system memory 402, a display 403 (e.g., touchscreen, flat-panel), a local wired point-to-point link (e.g., USB) interface 404, various network I/O functions 405 (such as an Ethernet interface and/or cellular modem subsystem), a wireless local area network (e.g., WiFi) interface 406, a wireless point-to-point link (e.g., Bluetooth) interface 407 and a Global Positioning System interface 408, various sensors 409_1 through 409_N, one or more cameras 410, a battery 411, a power management control unit 412, a speaker and microphone 413 and an audio coder/decoder 414.

An applications processor or multi-core processor 450 may include one or more general purpose processing cores 415 within its CPU 401, one or more graphical processing units 416, a main memory controller 417, an I/O control function 418 and one or more image signal processor pipelines 419. The general purpose processing cores 415 typically execute the operating system and application software of the computing system. The graphics processing units 416 typically execute graphics intensive functions to, e.g., generate graphics information that is presented on the display 403. The memory control function 417 interfaces with the system memory 402. The image signal processing pipelines 419 receive image information from the camera and process the raw image information for downstream uses. The power management control unit 412 generally controls the power consumption of the system 400.

Each of the touchscreen display 403, the communication interfaces 404-407, the GPS interface 408, the sensors 409, the camera 410, and the speaker/microphone codec 413, 414 all can be viewed as various forms of I/O (input and/or output) relative to the overall computing system including, where appropriate, an integrated peripheral device as well (e.g., the one or more cameras 410). Depending on implementation, various ones of these I/O components may be integrated on the applications processor/multi-core processor 450 or may be located off the die or outside the package of the applications processor/multi-core processor 450.

In an embodiment one or more cameras 410 includes an integrated traditional visible image capture and time-of-flight depth measurement system such as the system 300 described above with respect to FIGS. 3a through 3c. Application software, operating system software, device driver software and/or firmware executing on a general purpose CPU core (or other functional block having an instruction execution pipeline to execute program code) of an applications processor or other processor may direct commands to and receive image data from the camera system.

In the case of commands, the commands may include entrance into or exit from any of the 2D, 3D or 2D/3D system states discussed above with respect to FIGS. 3a through 3c. Additionally, commands may be directed to the illuminator to specify a particular one or more partitions of the partitioned field of view to be illuminated. The commands may additionally specify a sequence of partitions to be illuminated in succession so that a larger region of interest is illuminated over a period of time.

Embodiments of the invention may include various processes as set forth above. The processes may be embodied in machine-executable instructions. The instructions can be used to cause a general-purpose or special-purpose processor to perform certain processes. Alternatively, these processes may be performed by specific hardware components that contain hardwired logic for performing the processes, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, FLASH memory, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. (canceled)

2. A computer-implemented method comprising:
identifying a sub-region of interest within a field of view of an illuminator of a depth camera;
identifying a subset of a plurality of arrays of light sources that are associated with the illuminator and that are each associated with the sub-region of interest;
selecting a sequence with which to individually activate each array of light sources of the subset; and
individually activating each array of light sources of the subset according to the sequence.

3. The method of claim 2, wherein the entire sub-region of interest is illuminated in sequence.

4. The method of claim 3, wherein illumination power consumption is limited to no more than is consumed by a single array of light sources.

5. The method of claim 3, wherein illumination power consumption is permitted to scale with a quantity of simultaneously active arrays of light sources.

6. The method of claim 2, wherein identifying a sub-region of interest within the field of view comprises determining that a hand gesture is to be recognized.

7. The method of claim 2, wherein the light sources comprise infrared light sources.

8. The method of claim 2, wherein individually activating each array of light sources of the subset according to the sequence comprises:
individually activating a particular light source of the subset; and
deactivating all other light sources of the subset.

9. The method of claim 2, wherein selecting the sequence with which to individually activate each array comprises determining a power budget for illuminating the sub-region of interest.

10. A system comprising:
one or more computers and one or more storage devices storing instructions that are operable, when executed by the one or more computers, to cause the one or more computers to perform operations comprising:
identifying a sub-region of interest within a field of view of an illuminator of a depth camera;
identifying a subset of a plurality of arrays of light sources that are associated with the illuminator and that are each associated with the sub-region of interest;
selecting a sequence with which to individually activate each array of light sources of the subset; and
individually activating each array of light sources of the subset according to the sequence.

11. The system of claim 10, wherein the entire sub-region of interest is illuminated in sequence.

12. The method of claim 11, wherein illumination power consumption is limited to no more than is consumed by a single array of light sources.

13. The system of claim 11, wherein illumination power consumption is permitted to scale with a quantity of simultaneously active arrays of light sources.

14. The system of claim 10, wherein identifying a sub-region of interest within the field of view comprises determining that a hand gesture is to be recognized.

15. The system of claim 10, wherein the light sources comprise infrared light sources.

16. The system of claim 10, wherein individually activating each array of light sources of the subset according to the sequence comprises:
individually activating a particular light source of the subset; and
deactivating all other light sources of the subset.

17. The system of claim 10, wherein selecting the sequence with which to individually activate each array comprises determining a power budget for illuminating the sub-region of interest.

18. A non-transitory computer-readable medium storing software comprising instructions executable by one or more computers which, upon such execution, cause the one or more computers to perform operations comprising:
identifying a sub-region of interest within a field of view of an illuminator of a depth camera;
identifying a subset of a plurality of arrays of light sources that are associated with the illuminator and that are each associated with the sub-region of interest;
selecting a sequence with which to individually activate each array of light sources of the subset; and
individually activating each array of light sources of the subset according to the sequence.

19. The medium of claim 18, wherein the entire sub-region of interest is illuminated in sequence.

20. The medium of claim 19, wherein illumination power consumption is limited to no more than is consumed by a single array of light sources.

21. The medium of claim 19, wherein illumination power consumption is permitted to scale with a quantity of simultaneously active arrays of light sources.

22. A method, comprising:
receiving a command to illuminate a particular partition of a partitioned field of view of an illuminator;
enable an array of light sources that is dedicated to the particular partition;
collect light from the light source array and direct the collected light toward the partition to illuminate the partition;
detect at least a portion of the light after it has been reflected from an object of interest within the partition and compare respective arrival times of the light against emission times of the light to generate depth information of the object of interest.
